(19) United States
(12) Patent Application Publication
(10) Pub. No.: US 2008/0202435 A1
(43) Pub. Date: Aug. 28, 2008

(54) Ground based wildlife feeder

(76) Inventor: David Nowacek, San Antonio, TX (US)

Correspondence Address: JACKSON WALKER, L.L.P., 112 E. PECAN, SUITE 2400, SAN ANTONIO, TX, 78205, US

(21) Appl. No.: 12/069,371

(22) Filed: Feb. 8, 2008

Related U.S. Application Data
(60) Provisional application No. 60/903,786, filed on Feb. 27, 2007.

(51) Int. Cl. A01K 5/00

(52) U.S. Cl. 119/51.01

(57) ABSTRACT

A wildlife feeder having a conical lower section defining an inner volume and an upper section, typically cylindrical. Between the lower section and the upper section is located a spinner tray, which is fed by an auger that descends into the inner volume, where particulate feed is located. The lower section has a fill opening, which is located when the wildlife feeder rests on the ground, approximately 15 to 45 inches off the ground, for ease of loading wildlife feed from a feedbag located on a vehicle, such as a pickup truck.

This application claims priority and incorporates by reference provisional patent Ser. No. 60/903,786, filed Feb. 27, 2007.

### FIELD OF THE INVENTION

Wildlife feeders, more particularly, a wildlife feeder designed to rest on or near the ground.

### BACKGROUND OF THE INVENTION

Wildlife feeders are typically designed to have a body, which is mounted on long legs, to suspend the body of the feeder high above the ground. This keeps the wildlife feeder out of reach of the animals. These wildlife feeders that are located high above the ground typically have some form of motorized means for the casting of particulate feeder matter, such as corn, away from the feeder. The motors are often set on timers to throw out the feed at the same time of day (for example, evening) to “train” the wildlife to come to the feeder at a given time. Because feeders are often used in remote areas, solar collectors are often used to charge batteries, which will run the motor. Various types of broadcasting or feed systems are provided, which are designed to move the particulate feed from a storage hopper within the body of the feeder and hurl it or otherwise move it outside the feeder so it falls to the ground.

Typical prior art feeders, such as the type described above, are loaded from the top.

However, the body of the feeder is usually several feet high and the feeder is on long legs, the legs often being another 5 to 8 feet high. The result is that to load the body of the feeder, one will typically use a ladder. Placing the ladder adjacent the feeder and then hauling up a 40 lb. bag of feed and carefully loading it into the feeder while being 5-10 feet off the ground is precarious and there have been a number of accidents in which the hunter, in the process of loading the feeder, has accidentally fallen and been severely injured. In one case in particular, an acquaintance of the inventor fell onto a stake and was fatally wounded.

Thus, safety is a design objective. Further, another design objective is durability. A safe, durable wildlife feeder can address some of the shortcomings of the prior art, but still effectively serve the purposes of prior art feeders. Thus, a number of shortcomings in prior art feeders are addressed in Applicant's novel, ground based feeder, which shortcomings of prior art feeders are addressed without limiting the effectiveness of the prior art feeders to achieve their functions.

Benefits—prior art raised or gravity flow feeders allow wildlife to “bump” the feeder or actually manipulate the spinner thereby allowing the feed to fall to the ground. This is counter to the purpose of “timed dispersion” and wastes feed.

Cone shape increases stability and makes it difficult for squirrels, raccoons and other varmints from climbing on the unit and manipulating the spinner or otherwise damaging the components.

### SUMMARY OF THE INVENTION

An embodiment of the wildlife feeder typically comprises a body, the body consisting of a cone shape section and a cylindrical section. Within the cone shape section is an interior volume. The cone shape may have a curved rounded bottom, so the feeder can rock when on a flat ground surface, or a flat bottom surface.

Inside the inner volume of the cone and extending up into a typically cylindrical section of the body is a screw auger assembly that will move particulate feed matter from the bottom of the feeder up into the cylindrical section. In the cylindrical section is mounted a motor, which will drive the screw auger. The screw auger goes up into the cylindrical section and dumps particulate feed out onto a spinning disk. The spinning disk throws particulate feed outward towards a series of windows, the windows having adjustable shutters to adjust or selectively set the window openings. With particulate feed dumped onto a spinning disk, the feed is hurled toward the windows and passes through the windows and outside of the feeder where it will fall to the ground. Of course, some of the particulate feed will strike the inner surface of the cylindrical housing, but that may simply fall back down to the bottom of the cone to be scooped up again by the screw auger.

An access door and access opening provides for easy loading, without a ladder, of the body. That is, since the wildlife feeder sits on the ground (i.e., legless or short legs), you don't have to get on a ladder to load it and the access door is about 12-36 inches above the bottom and this makes for easy loading. In fact, the entire vertical axis, bottom to top, of the wildlife feeder is typically in the order of a magnitude of 3-6 feet.

### BRIEF DESCRIPTION OF THE DRAWINGS

FIG. 1 is a perspective view of Applicant's wildlife feeder 10.

FIG. 1A is a side elevational view of the windows having a window shutter.

FIG. 1B is a view of the wildlife feeder having a planar, flat bottom.

FIG. 1C is a view of the wildlife feeder having a flat but convex or outwardly curved bottom.

FIG. 2 is a cross-section of Applicant's novel wildlife feeder.

FIG. 3 is a cross-sectional cutaway view showing the bottom of the auger assembly in an alternative preferred embodiment.

FIG. 4 is a top elevational view through sleeve 64 showing the manner in which the motor shaft engages the screw.

FIG. 4A is a detailed cross-sectional elevational view of the section between the motor and the top of the auger assembly showing the manner of engagement of the motor to the auger and the auger assembly to the spinner.

FIG. 5 is a top elevational view with the upper housing removed showing the vertical axis of the body and the top of the auger assembly.

FIG. 6 is a detailed perspective view of the manner in which members and collars are used to hold and fixedly locate the tube of the auger assembly.

FIG. 7 is a detailed view of an interior floor of the upper housing illustrating a manner in which the battery and motor may be mounted to the upper housing.

FIG. 8 is a side elevational view showing a manner in which Applicant's novel wildlife feeder 10 locates a fill opening and a fill opening lid or cover for convenient loading of the wildlife feeder from feedbags sitting on a tailgate of a pickup truck or other vehicle.

FIG. 9 is a top elevational view, partially cut away, of an alternate preferred embodiment of Applicant's novel wildlife feeder.

FIG. 10 is a top elevational view of an alternate preferred embodiment of Applicant's novel wildlife feeder.

### DETAILED DESCRIPTION OF THE PREFERRED EMBODIMENT

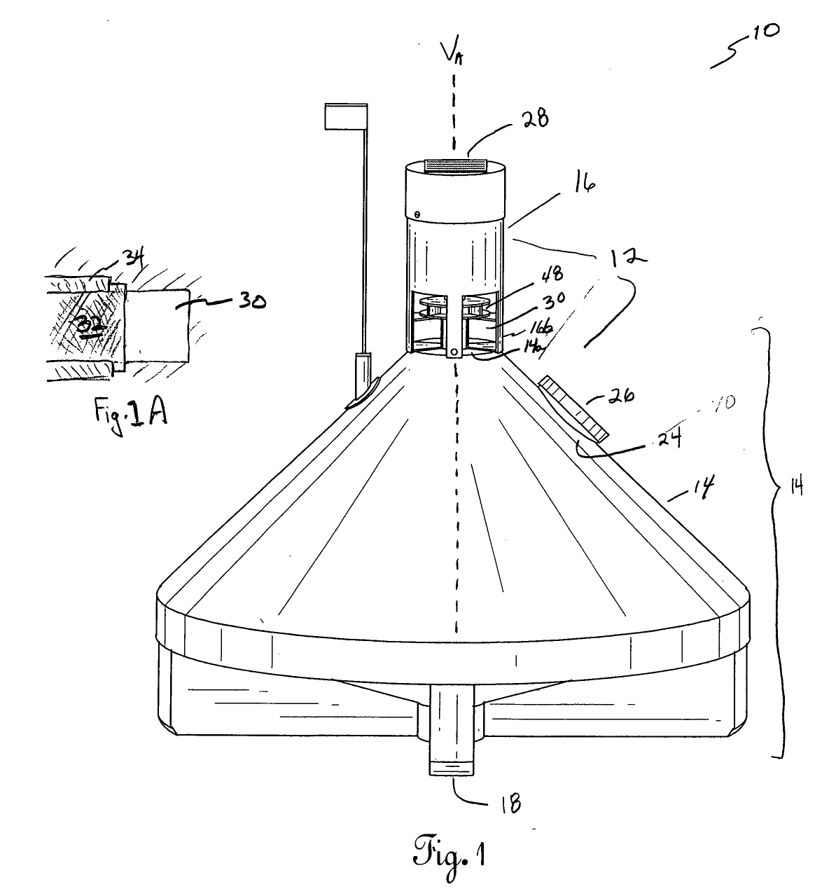

FIGS. 1, 2, 3, 4, 4A, and 5 illustrate various views of a preferred embodiment of Applicant's novel wildlife feeder 10. The wildlife feeder is designed to distribute feed, including, without limit, particulate feed (PF) to wildlife.

Applicant's wildlife feeder includes a body 12, which may include a lower or conical section 14 and an upper housing or upper section 16. The lower section 14 may include a bottom wall 18, flat or rounded, that is designed to sit on the support surface, typically the ground. The body 12 typically includes a lower or cone section 14, which defines an inner volume 20 and may have a floor 22 typically concave or an inverted cone shape (see FIG. 2).

A fill opening 24 may be provided with a fill lid or door 26 for removable or hinged attachment to the body, typically the cone section 14, which removal or pivoting will allow one to place feed within the inner volume of the body.

A solar collector 28 may be mounted to an external surface of the body in a location that will provide suitable exposure to the sun. Windows or openings 30 are provided in the body, here illustrated in the upper housing 16. The windows include shutters ordiverters 32 as seen in FIG. 1A, which shutters or diverters will allow the user to selectively control the size of the opening of the windows. If the shutters are provided, they may be mounted on shade rails 34.

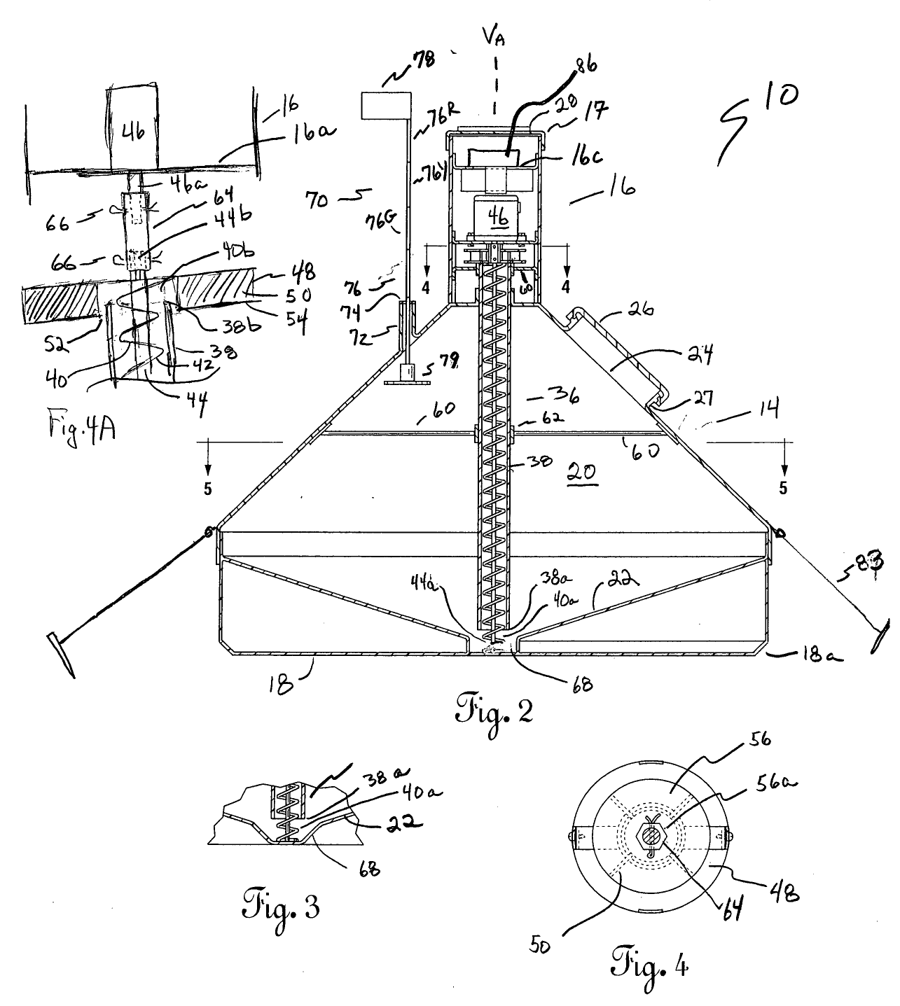

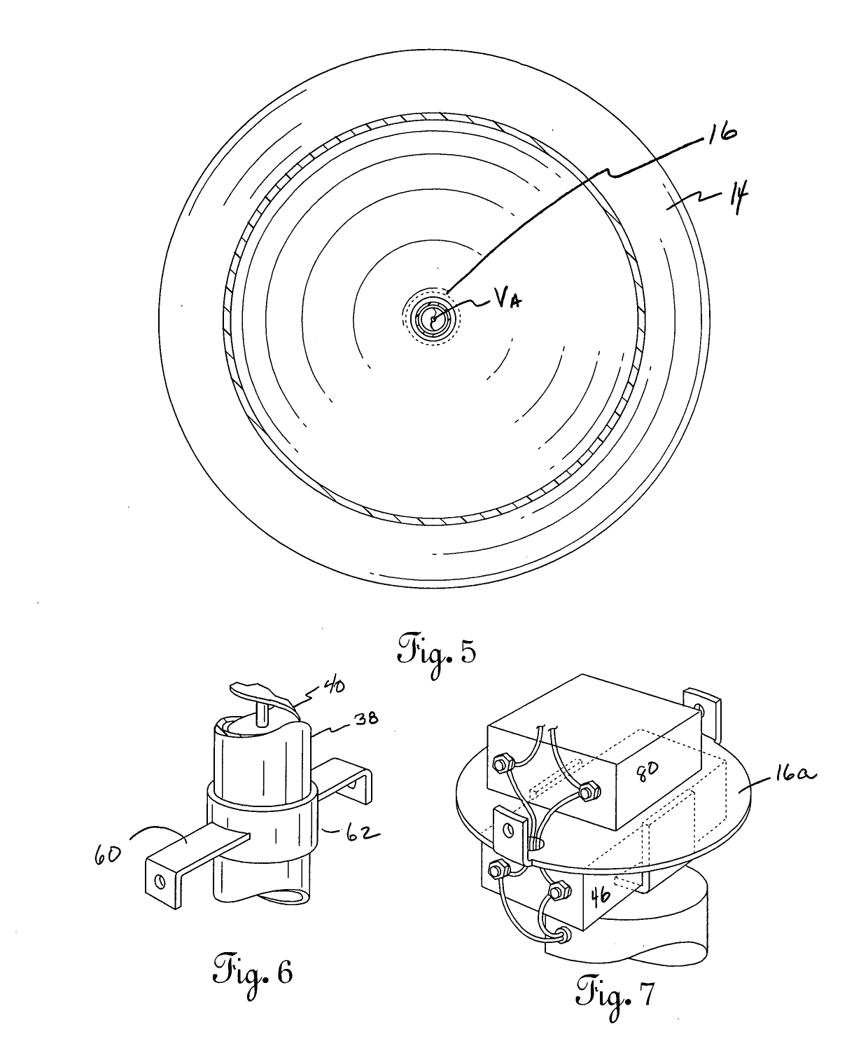

As can be seen in FIGS. 1 and 2, the lower section may have outer walls defining a cone. The term “cone,” however, is used here and in the claims in a more expansive manner than is typical. Namely, the term “cone” or “cone-shaped” refers to the body having a lower section with sloped outer walls that diverge from the top down. Thus, when cone or cone-shaped is used, it may define the shape as set forth in FIGS. 1 and 2, as well as in FIGS. 9 and 10, or any other shape with sloped walls converging towards the top of the lower section. Wildlife feeder 10 has a vertical axis Va as seen in FIGS. 1 and 2.

The wildlife feeder is seen to comprise a screw auger assembly 36, which assembly includes a hollow tube 38 having a bottom end 38a and a top end 38b, and a screw or screw auger 40 dimensioned to fit slidably therein. There may be a gap of between ⅛ to ¾ inch between the width or OD of the screw 40 and the ID of tube 38, which gap will help prevent the jamming of particulate feed being lifted from the inner volume to a disc or spinner 48 as set forth in more detail below. Screw or auger 40 of screw auger assembly 36 includes blades 42 and a shaft 44.

The screw or auger 40 has a bottom end 40a and a top end 40b, and the shaft 44 has a bottom end 44a and top end 44b. Motor 46 has a shaft 46a. As seen in FIG. 4A, motor 46 may be mounted to a floor 16a located within the upper housing 16 and may include a motor shaft 46a extending vertically downward.

A disc or spinning tray 48 is seen to engage the screw auger assembly 36. Disc or tray 48 is seen to have walls or dividers 50 and a disc hole 52 on a bottom surface 54 thereof. Referring to FIGS. 4 and 4A, upper surface 56 of spinner 48 includes a central hexagonal cutout 56a.

Turning back to FIGS. 4 and 4A, the manner in which the disc attaches to the auger assembly and the screw of the auger assembly to the motor shaft is set forth in more detail. Members 60 in collars 62 fixedly locate hollow tube 38 with respect to the body in the manner set forth in more detail below. Motor shaft 46a is coupled to shaft end 44b (which may be hexagonal) and pinned through the use of a sleeve 64. That is to say, sleeve 64 has holes through the walls thereof near a top end and a bottom end thereof, which holes may be aligned with holes in top end 44b of shaft and pinned with pin 66 as well as a hole in motor shaft 46a and pinned with another pin 66 for a second time (see FIG. 4A). This allows the entire screw or auger 44 to hang suspended from motor 46. Motor 46 is seen to be fixedly engaged with floor 16a.

Thus, screw auger assembly 36 may be located by using members 60 in collar 62, which will hold hollow tube 38 and screw auger 40 is removably and toollessly pinned, through the use of sleeve 64 and pins 66, to the motor unit. Therefore, motor 46 both drives auger 40, and also locates and suspends auger 40.

Further details are appreciated with reference to FIG. 2. Here it is seen that lower end 40a of auger extends past lower end 38a of the tube, but typically hangs suspended off the bottom floor 22 of the inner volume. While the screw may be suspended or received on bushing or bearings against the inner floor (as seen in FIG. 3), in a preferred embodiment, the lower end of the screw simply is suspended slightly above the bottom floor.

With a gap between the blades and the inner diameter of the tube, there may be some slight lateral or pendulum type movement of the screw inside the tube, but this in fact may be beneficial to help loosen feed to avoid jamming between the screw and the inner walls of the tube.

With reference to FIG. 4a, it is seen that the top or upper end of tube 38a extends through disc hole 52 and bottom surface 54 of spinner or disc 48. Upper surface 56 has a hexagonal hole 56a and matches the hexagonal shape of the top end 44b of shaft 44. When the motor turns, the sleeve coupling will assure that the shaft 44 turns, therefore, the spinner turns. The screw and feed is transported from the bottom of the inner volume of the body up to the spinner tray where it will be cast out through windows.

As seen in FIGS. 2 and 3A, a well 68 may be located at the apex of the inwardly slanted floor 22. The inwardly slanted floor 22 helps ensure that particulate feed will gravity feed towards the apex or lowest point of the concave or inverted cone-shaped floor 22. A well 68 may be provided at the apex, which will help assist feed to congregate in the area adjacent the exposed screw where it will be picked up by the rotating screw when the motor is running.

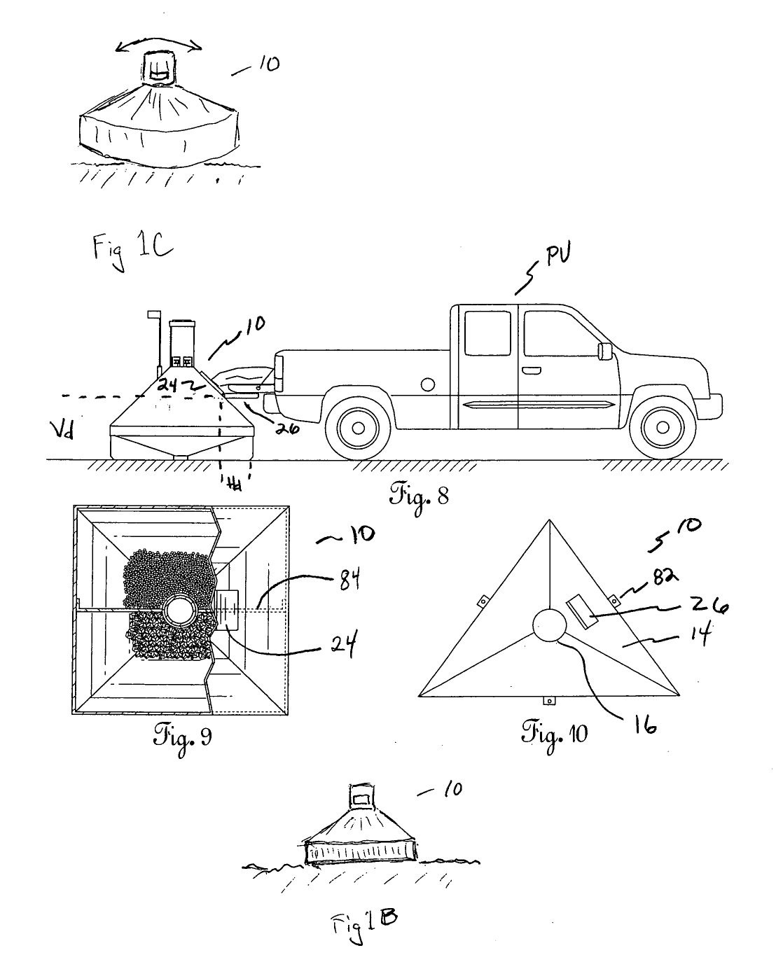

Going back to FIGS. 1 and 2, details of fill opening 24 may be described. Fill opening 24 is typically provided on the slanted surface of lower section 24 to provide access to the inner volume of the lower section to put in the wildlife feed. The fill opening may be circular, rectangular or any other suitable shape. It typically includes the door cover or lid 26, which may screw on or pivot on. For example, the fill door cover or lid 26 may pivot downward as set forth in FIG. 8. Moreover, it may have a lip 27 surrounding and standing perpendicular adjacent the fill opening 24.

FIG. 1B is a view of the wildlife feeder having a planar, flat bottom. FIG. 1C is a view of the wildlife feeder having a flat but convex or outwardly curved bottom. The curved bottom allows the wildlife feeder to “rock” a little and helps move particulate wildlife feed down the sloped floor to the screw.

One of the beneficial features of Applicant's wildlife feeder 10 is the location of fill opening 24. That is to say, as may be appreciated with reference to the figures, including FIG. 8, that fill opening 24 has a vertical displacement above the ground, typically on which the bottom wall 18 is residing, which vertical displacement is sufficient to align with the tailgate of a pickup truck PU or the bed of an SUV in a manner that allows the feedbag in a pickup truck or SUV to be laid flat, cut open with an opening adjacent the fill opening. This vertical displacement of the fill opening will then allow one to simply lay a bag over or with a feedbag vertically mounted cut it open, such that particulate feed may drain directly into the fill opening 24. Applicant's feeder either sits that on the ground or has only short legs, but keeps the fill opening within easy reach, precluding use of a ladder to fill it.

As seen in FIG. 8, vertical displacement of lowest point in fill opening 24 may be described as Vd and the horizontal distance from the widest point of the lower housing may be designated horizontal distance Hd. Vd is typically between about 15 and 40 inches, and Hd between about 10 and 40 inches. These ranges are typical and allow for convenient loading of particulate wildlife feed delivered in bags and poured into the wildlife feeder 10 as seen in FIG. 8, but there may be any range that allows coupling between a vehicle and the opening.

With reference to FIG. 1, it is seen that top section or upper housing 16 may include legs 16b to attach to lower housing or cone section 14, which legs are used to define windows or openings 30 and to support and locate the upper housing. Moreover, it is seen that the top apex 14a of cone section 14 may be open, or at least partially open, such that when the spinner is spinning and dispensing particulate feed, any particulate feed that strikes the inner walls of upper housing 16 would tend to fall back into the inner volume or, if it strikes the outer walls, will simply roll down under the impetus of gravity and end up on the ground. On the other hand, apex 14a may be closed against the tube to keep out rain, etc.

An additional feature of Applicant's novel wildlife feeder is a fill level indicator assembly 70, which functions to indicate the level of wildlife feed within the wildlife feeder. However, Applicant's preferred fill level indicator assembly 70 has additional features that allow it to indicate the level of feed to an observer some distance away from the wildlife feeder.

Fill level indicator assembly 70 may include a cylindrical tube slide 72 preferably with a seal 74 on the upper end thereof. Slidably received within tube 72 is a rod 76. Rod 76 has a heavy weight or flat plate 79 in a lower section, which lower section is at least partially within the body, and an upper section which is at least partially outside of the body. Rod 76 may have a flag or pennant 78 at an upper end thereof, which may be large and brightly colored so as to be easily spotted from a distance. Moreover, rod 76 may be comprised of, at least partially, color-coded sections. For example, 76r may be red, 76y may be yellow, and 76g may be green. When located along the cylindrical rod with green the lowest position and red the top position, one can visually see from a distance, not only that the rod is sitting low in comparison to the body, but may be able to see only red exposed, indicating a low feed level or, if some yellow is exposed, a moderate feed level. Plate 79 has a planar or horizontal section so it will tend to sit on top of the particulate feed and is heavy enough to allow it to slide as the feed level lowers.

FIGS. 1, 2, and 5 also illustrate the manner in which motor 46, screw auger assembly 36, and the conical-shaped floor 22 are aligned with the vertical axis Va of wildlife feeder 10.

FIG. 7 illustrates a manner in which motor 46 may engage or be mounted to floor 16a of the upper housing, which may also support a battery 80, such as a DC battery powered by the solar collector 28.

FIG. 2 shows how bottom wall 18 is typically flat, but that the perimeter or edge 18a may be beveled so as to allow one to slide the feeder across the ground, with more ease than a sharp perpendicular arrangement between a bottom wall and a side wall would provide.

FIG. 10 illustrates an alternate cone shape, as well as the use of angled legs 82, which may engage the lower section adjacent the ground for holding the wildlife feeder to the ground. In the alternative, a cable and stake assembly 83 may be provided as set forth in FIG. 2.

An upper floor 16c may be provided in the upper housing 16, which may be used for storage or location of small items. A lid 17 may engage the upper housing to provide access to the upper storage unit.

Walls defining a divider 84 may be provided to divide the inner volume of the lower section into two or more sections as seen in FIG. 9. Fill opening 24 may be located so that one of the dividers splits the fill opening. For an alternative there may be more than one fill opening, each one providing access to the sub-compartments produced by dividing the inner volume. As see in FIG. 9, wildlife feed of a first type may be placed in a first sub-compartment of the inner volume of the wildlife feeder and a second type may be placed in a second sub-compartment of the inner volume, etc. The walls defining the divider would end, typically at or near where the bottom end of the lower end 38a of tube 38 terminates, allowing the screw as it rotates to pick up feed from both sub-compartments.

Turning back to FIG. 2, it is seen that Applicant's novel wildlife feeder 10 includes a controller and timing unit 86 and a wiring harness (not shown), such controllers, timers, wiring harnesses, batteries and motors as known in the art.

The body, the lower section, and the sloping walls may be constructed from plastic (for example, molded plastic), HDPE, sheet metal or other “slippery” metal such that animals, such as rodents, will have trouble climbing up to the feed tray.

Although the invention has been described with reference to specific embodiments, this description is not meant to be construed in a limited sense. Various modifications of the disclosed embodiments, as well as alternative embodiments of the inventions, will become apparent to persons skilled in the art upon the reference to the description of the invention. It is, therefore, contemplated that the appended claims will cover such modifications that fall within the scope of the invention.

1. A wildlife feeder comprising:
a body having an inner volume and a bottom wall, the body adapted to hold wildlife feed;
a screw auger assembly, including a screw and a tube for lifting the wildlife feed contained in the body;
a spinner engaging the screw auger assembly for receiving wildlife feed and spreading it; and
a motor for rotating the spinner and the screw of the screw auger assembly.

2. The wildlife feeder of claim 1, wherein the body includes a wall defining a fill opening, the fill opening having a lower boundary between 15 and 40 inches above the bottom wall.

3. The wildlife feeder of claim 1, wherein the body includes walls defining a fill wherein the fill opening is displaced inward from an outer perimeter of the body between 10 and 40 inches therefrom.

4. The wildlife feeder of claim 1, wherein the body includes a lower section having a conical shape.

5. The wildlife feeder of claim 4, wherein the body includes walls defining a fill opening, the fill opening having a lower boundary between 15 and 40 inches above the bottom wall; and wherein the fill opening is displaced inward from an outer perimeter of the body between 10 and 40 inches therefrom.

6. The wildlife feeder of claim 1, wherein the body includes a cone-shaped lower section and an upper housing engaged with the cone-shaped lower section, the upper housing with openings, the openings adjacent the spinner.

7. The wildlife feeder of claim 6, wherein the body includes walls defining a fill opening, the fill opening having a lower boundary between 15 and 40 inches above the bottom wall; and wherein the fill opening is displaced inward from an outer perimeter of the body between 10 and 40 inches therefrom.

8. The wildlife feeder of claim 1, wherein the screw of the auger assembly is dimensioned for receipt within the tube, except at the top and the bottom end thereof, wherein the screw extends above the tube and below the tube.

9. The wildlife feeder of claim 8, wherein the body includes walls defining a fill opening, the fill opening having a lower boundary between 15 and 40 inches above the bottom wall; and wherein the fill opening is displaced inward from an outer perimeter of the body between 10 and 40 inches therefrom.

10. The wildlife feeder of claim 9, wherein the motor is located in the upper housing and engages the screw such that the screw is releasably and pinned to the motor.

11. The wildlife feeder of claim 9, further including members to locate the tube with respect to the body and wherein the spinner includes a bottom surface with a central opening and the tube is located so that the top end of the tube is above the bottom surface of the spinner and extends through the central opening of the spinner.

12. The wildlife feeder of claim 11, wherein the body includes a wall defining a fill opening, the fill opening having a lower boundary between 15 and 40 inches above the bottom wall.

13. The wildlife feeder of claim 11, wherein the body includes the fill opening in an outer perimeter and wherein the fill opening is displaced inward from the outer perimeter between 15 and 40 inches therefrom.

14. The wildlife feeder of claim 1, further including means to secure the body to a ground surface.

15. The wildlife feeder of claim 1, further including a floor in the inside of the body, the floor being concave shaped and having an apex; further including means to locate the tube of the auger assembly so that the bottom end thereof is just above the apex.

16. The wildlife feeder of claim 15, wherein the apex includes a well structure.

17. The wildlife feeder of claim 1, further including a feed level indicator engaging the body and having a portion that is outside the body and a portion that is inside the body.

18. The wildlife feeder of claim 17, wherein the feed level indicator includes a rod member having a lower plate for engaging wildlife feed within the inner volume, the rod member extending from the body and having a visible gauge on the surface thereof for indicating the amount of wildlife feed within the body of the wildlife feeder.

19. The wildlife feeder of claim 1, wherein the body has a vertical axis and a concave floor, the concave floor having an apex and wherein the vertical axis extends from the apex of the concave floor; wherein the auger assembly and motor are aligned with the vertical axis of the body.

20. The wildlife feeder of claim 19, wherein the body includes a lower section having a conical shape.

21. The wildlife feeder of claim 20, wherein the lower body is partially comprised of at least one of the following materials: plastic, HDPE or sheet metal.

22. The wildlife feeder of claim 20, wherein the lower body includes a fill opening having a lip thereon.

23. The wildlife feeder of claim 22, wherein the body includes a wall defining a fill opening, the fill opening having a lower boundary between 15 and 40 inches above the bottom wall.

24. The wildlife feeder of claim 1, wherein the body includes a cone-shaped lower section having an inner volume and a divider, the divider dividing the inner volume into at least two sections.

25. A wildlife feeder comprising:
a body having an inner volume and a bottom wall, the body adapted to hold wildlife feed, the body further including an upper housing and a conical lower section, and the upper housing having windows and the conical lower section including a concave floor having an apex;
a screw auger assembly including a screw and a tube for lifting wildlife feed container in the body, the screw auger assembly aligned with the vertical axis of the body;
a spinner engaged with the screw near the top end thereof, the spinner located adjacent the windows of the upper housing;
a motor located in the upper housing having a motor shaft removably engaging the screw of the screw auger, the motor mounted so the motor shaft is aligned with the vertical axis; and
members for locating the tube of the screw auger assembly, the members engaging the body and the members for holding the tube rigidly with respect to the body, the tube dimensioned and located such that the screw extends from the removed ends of the tube;
wherein the conical lower section of the body includes walls defining the fill opening, the fill opening having a lower boundary, the lower boundary between 15 and 40 inches above the bottom wall.
